(19) United States
(12) Patent Application Publication
(10) Pub. No.: US 2025/0369131 A1
(43) Pub. Date: Dec. 4, 2025

(54) APPARATUS FOR REMOVING NITROGEN OXIDES AND METHOD FOR MANUFACTURING AMMONIUM NITRATE USING THE SAME

(71) Applicant: KOREA INSTITUTE OF ENERGY TECHNOLOGY, Naju-si (KR)

(72) Inventors: Wonyong CHOI, Seoul (KR); Donglai PAN, Naju-si (KR)

(21) Appl. No.: 19/086,159

(22) Filed: Mar. 21, 2025

(30) Foreign Application Priority Data
May 31, 2024 (KR) 10-2024-0071215

(51) Int. Cl. C25B 11/032; C25B 11/042; C25B 11/048

(52) U.S. Cl. CPC C25B 11/032; C25B 11/042; C25B 11/048

(57) ABSTRACT

Provided are an ammonium nitrate manufacturing apparatus, which is an apparatus for manufacturing ammonium nitrate from a diluted nitrogen oxide, including: a cathode; an anode which is arranged to be opposite to and spaced apart from the cathode; and an electrolyte placed between the anode and cathode, wherein the cathode and the anode are independently of each other gas diffusion electrodes including: a porous substrate; metal organic frameworks (MOFs) dispersed in the porous substrate; and a metal catalyst placed on one surface of the porous substrate, and a method for manufacturing ammonium nitrate using the same.

### CROSS-REFERENCE TO RELATED APPLICATIONS

This application claims priority under 35 U.S.C. § 119 to Korean Patent Application No. 10-2024-0071215, filed on May 31, 2024, in the Korean Intellectual Property Office, the disclosure of which is incorporated herein by reference in its entirety.

### TECHNICAL FIELD

The following disclosure relates to an apparatus for producing ammonium nitrate from a diluted nitrogen oxide and a method for manufacturing ammonium nitrate.

### BACKGROUND

Waste gas which is emitted in a process of burning coal, hydrocarbon-based fuels, organic nitrogen compounds, and the like contains nitrogen oxides (NOₓ). Since the nitrogen oxides (NOₓ) contained in the waste gas are emitted into the atmosphere to pollute the atmosphere and cause environmental problems such as photochemical smog, acid rain, fine dust, and ozone production, studies for removing nitrogen oxides by capturing and converting the captured nitrogen oxides into high value-added compounds are in progress.

A method for converting nitrogen oxides into harmless N₂ using a selective catalytic reduction (SCR) process is currently the most widely used. However, since the selective catalytic process requires a large amount of expensive reducing agents such as ammonia (NH₃) and hydrogen (H₂), it is not economical, and since it is performed at a high temperature of 200° C. to 400° C., it consumes a lot of energy.

Meanwhile, since the nitrogen oxides have low mass transfer efficiency in an aqueous solution, when waste gas including diluted nitrogen oxides is directly used as a reactant during nitrogen oxide conversion, a nitrogen compound to be desired may not be obtained from the nitrogen oxides, and only when a high-concentration nitrogen oxide obtained by purifying the waste gas is used as a reactant, the nitrogen oxide conversion reaction may be performed.

### SUMMARY

An embodiment of the present disclosure is directed to providing an ammonium nitrate manufacturing apparatus which may produce ammonium nitrate with a high conversion rate from a reactant including a diluted nitrogen oxide, and a method for manufacturing ammonium nitrate using the same.

Another embodiment of the present disclosure is directed to providing an economical and energy-efficient ammonium nitrate manufacturing apparatus and a method for manufacturing ammonium nitrate using the same.

In one general aspect, an ammonium nitrate manufacturing apparatus, which is an apparatus for manufacturing ammonium nitrate from a diluted nitrogen oxide, includes a cathode; an anode which is arranged to be opposite to and spaced apart from the cathode; and an electrolyte placed between the anode and cathode, wherein the cathode and the anode are independently of each other gas diffusion electrodes including: a porous substrate; metal organic frameworks (MOFs) dispersed in the porous substrate; and a metal catalyst placed on one surface of the porous substrate.

In an exemplary embodiment, the cathode and the anode may include different types of metal catalysts.

In an exemplary embodiment, the cathode may contain copper as the metal catalyst.

In an exemplary embodiment, the anode may contain nickel (Ni), nickel oxide (NiO), or a combination thereof as the metal catalyst.

In an exemplary embodiment, the metal organic frameworks (MOFs) may be dispersed inside the pores and on the surface of the pores of the porous substrate.

In an exemplary embodiment, the metal organic frameworks (MOFs) may include coordinatively unsaturated metal sites (CUMSs).

In an exemplary embodiment, the porous substrate may include a porous carbon body.

In an exemplary embodiment, the apparatus may further include a first fluid housing part placed on one surface of the cathode; and a second fluid housing part placed on one surface of the anode.

In an exemplary embodiment, the first fluid housing part may include a first fluid inlet and a first fluid outlet, and the second fluid housing part may include a second fluid inlet and a second fluid outlet.

In an exemplary embodiment, the apparatus may further include a flow path which connects the first fluid outlet and the second fluid inlet.

In an exemplary embodiment, the electrolyte may be housed in an electrolyte housing part placed between the anode and the cathode and brought into contact with at least a part of the anode and the cathode.

In an exemplary embodiment, the electrolyte housing part may include an electrolyte inlet and an electrolyte outlet on one side.

In an exemplary embodiment, the ammonium nitrate manufacturing apparatus may be a flow battery for converting nitrogen oxides.

In an exemplary embodiment, the anode, the cathode, and the electrolyte may be housed in a single chamber.

In another general aspect, a method for manufacturing ammonium nitrate using the ammonium nitrate manufacturing apparatus described above is provided.

The method for manufacturing ammonium nitrate according to the present disclosure includes: (S10) supplying a reactant containing a nitrogen oxide to a cathode and an anode of the ammonium nitrate manufacturing apparatus described above to produce an ammonium ion in the cathode and produce a nitrate ion in the anode; and (S20) reacting the nitrate ion and the ammonium ion to manufacture ammonium nitrate.

In an exemplary embodiment, (S20) may be performed in an electrolyte of the ammonium nitrate manufacturing apparatus.

In an exemplary embodiment, (S10) may be supplying the reactant to the cathode and the anode, respectively.

In an exemplary embodiment, (S10) may include: (S11) supplying a reactant containing a nitrogen oxide to the cathode to produce an ammonium ion; and (S12) supplying a reactant containing an unreacted nitrogen oxide discharged from the cathode to the anode to produce a nitrate ion.

In an exemplary embodiment, a content of the nitrogen oxide in the reactant may be 50 ppm or less.

Other features and aspects will be apparent from the following detailed description, the drawings, and the claims.

### BRIEF DESCRIPTION OF THE DRAWINGS

FIG. 1A is a schematic diagram showing a method for manufacturing a gas diffusion electrode according to an exemplary embodiment.

FIG. 1B is an X-ray diffraction spectrum of a cathode manufactured by the methods of Manufacturing Examples 4 to 7.

FIGS. 1C and 1D are scanning electron microscope images of copper nanowire and UIO-66, respectively.

FIGS. 1E and 1F are scanning electron microscope images of cross sections of carbon paper and the cathode according to Manufacturing Example 4, respectively.

FIGS. 1G to 1I are EDS mapping images of the cathode according to Manufacturing Example 4, and EDS element mapping images of C, Zr, and Cu, respectively.

FIG. 2A is a schematic diagram showing a diluted nitrogen oxide reduction reaction flow of a flow battery including the cathode according to an exemplary embodiment.

FIG. 2B is a linear sweep voltammetry curve of a nitrogen oxide reduction reaction of the cathodes according to Manufacturing Examples 4 to 7, respectively.

FIG. 2C is a graph showing NH₄⁺ production rates of the cathodes of Manufacturing Methods 4 to 7 under a 2% nitrogen oxide flow.

FIG. 2D is a graph showing Faradaic efficiency for NH₄⁺ of the cathodes according to Manufacturing Methods 4 to 7 under a 2% nitrogen oxide flow.

FIG. 2E is a graph showing NH₄⁺ production rates of the cathodes of Manufacturing Methods 4 to 7 under 20 ppm of a nitrogen oxide flow.

FIG. 2F is a graph showing Faradaic efficiency for NH₄⁺ of the cathodes of Manufacturing Methods 4 to 7 under 20 ppm of a nitrogen oxide flow.

FIG. 2G is a graph evaluating stability of the cathode according to Manufacturing Example 4 in 0.5 V vs. RHE.

FIG. 3A is a schematic diagram showing a nitrogen oxide adsorption and conversion process of the cathode according to an exemplary embodiment.

FIG. 3B is a nitrogen adsorption/desorption isotherm of the cathodes according to Manufacturing Example 1 to 3 and carbon paper.

FIG. 3C is a nitric acid temperature-programmed desorption (NO-TPD) of the cathodes according to Manufacturing Example 1 to 3 and carbon paper.

FIG. 3D is a graph calculating NO adsorption energy of carbon paper (CP), UIO-66, ZIF-8, ZIF-67, and copper (111) plane.

FIG. 4A is atomic models of a NiO catalyst and a Ni/NiO heterojunction catalyst.

FIG. 4B is an X-ray diffraction spectrum of metal catalysts manufactured by the methods according to Manufacturing Examples 9 to 11.

FIG. 4C is a scanning electron microscope image of the metal catalyst manufactured by the method of Manufacturing Example 11.

FIG. 4D is a transmission electron microscope image of the metal catalyst manufactured by the method of Manufacturing Example 11.

FIG. 4E is a TEM-EDX mapping image of the metal catalyst manufactured by the method of Manufacturing Example 11.

FIG. 4F is a high-resolution transmission electron microscope image of the metal catalyst manufactured by the method of Manufacturing Example 11.

FIG. 4G is a Ni 2p XPS spectrum of the metal catalysts manufactured by the methods of Manufacturing Examples 9 to 11.

FIG. 4H is an O 1s XPS spectrum of the metal catalysts manufactured by the methods of Manufacturing Examples 9 to 11.

FIG. 5A is a schematic diagram showing a nitrogen oxide capturing and conversion process of the anode according to an exemplary embodiment.

FIG. 5B is a graph showing the production yield and the Faradaic efficiency of the anodes according to Manufacturing Examples 12 to 14.

FIG. 5C is a graph showing the production yield and the Faradaic efficiency of the anodes according to Manufacturing Examples 11 and 14 under a 2% nitrogen oxide flow.

FIG. 5D is a graph showing the production yield and the Faradaic efficiency of the anodes according to Manufacturing Examples 11 and 14 under 20 ppm of a nitrogen oxide flow.

FIG. 5E is a graph measuring the NO₂⁻ and NO₃⁻ production yields according to the reaction time of the anodes according to Manufacturing Examples 11 and 14 in 1.7 V (vs RHE).

FIGS. 6A, 6B, and 6C are schematic diagrams showing the manufacturing apparatuses of ammonium nitrate according to Examples 1, 2, and 3, respectively.

FIG. 6D is a graph showing the ammonium nitrate production yield of the manufacturing apparatuses of ammonium nitrate according to Example 1 and Comparative Example 1.

FIG. 6E is a graph showing the ammonium nitrate production yield of the manufacturing apparatuses of ammonium nitrate according to Example 2 and Comparative Example 2.

FIG. 6F is a graph showing the ammonium nitrate production yield of the manufacturing apparatuses of ammonium nitrate according to Example 3 and Comparative Example 3.

FIG. 7 is a graph showing the NO utilization efficiency of the manufacturing apparatuses of ammonium nitrate according to Examples 1 to 3 and Comparative Examples 1 to 3.

### DETAILED DESCRIPTION OF EMBODIMENTS

An ammonium nitrate manufacturing apparatus of the present disclosure and a method for manufacturing ammonium nitrate using the same will be described in detail. The terms used in the present specification are selected to be as common as possible and are currently widely used while considering the function of the present disclosure, but they may vary depending on the intention of a person skilled in the art, a convention, the emergence of new technology, or the like. The technical and scientific terms used may have, unless otherwise defined, the meaning commonly understood by those of ordinary skill in the art to which the present invention pertains.

The terms such as “comprise” or “have” in the present specification and the appended claims mean that there is a characteristic or a constitutional element described in the specification, and as long as it is not particularly limited, a possibility of adding one or more other characteristics or constitutional elements is not excluded in advance.

In the present specification and the appended claims, the terms such as “first” and “second” are not used in a limited meaning but are used for the purpose of distinguishing one constituent element from other constituent elements.

A singular expression in the present specification and the appended claims includes a plural expression, unless otherwise explicitly specified as singular. In addition, a plural expression includes a singular expression, unless otherwise explicitly specified as plural.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the specification of the present disclosure, values which may be outside a numerical range due to experimental error or rounding off of a value are also included in the defined numerical range.

The term of degree “about” and the like used in the present specification and the attached claims are used in the sense of covering an allowable error when the allowable error exists.

Unless otherwise stated in the present specification, “selectivity” refers to Faradaic efficiency showing a ratio of charge used in manufacturing a product as compared with the total charge, when electrochemically converting a nitrogen oxide.

In the present specification and the attached claims, a “diluted nitrogen oxide (NO)” and a “low-concentration nitrogen oxide (NO)” refer to a fluid containing 50 ppm or less, 40 ppm or less, 30 ppm or less, or 20 ppm or less of a nitrogen oxide.

Waste gas which is emitted in a process of burning coal, hydrocarbon-based fuels, organic nitrogen compounds, and the like contains nitrogen oxides (NOₓ). Since the nitrogen oxides (NOₓ) contained in the waste gas are emitted into the atmosphere to pollute the atmosphere and cause environmental problems such as photochemical smog, acid rain, fine dust, and ozone production, studies for removing nitrogen oxides by capturing and converting the captured nitrogen oxides into high value-added compounds are in progress.

A method for converting nitrogen oxides into harmless N₂ using a selective catalytic reduction (SCR) process is currently the most widely used. However, since the selective catalytic process requires a large amount of expensive reducing agents such as ammonia (NH₃) and hydrogen (H₂), it is not economical, and since it is performed at a high temperature of 200° C. to 400° C., it consumes a lot of energy.

Meanwhile, since the nitrogen oxides have low mass transfer efficiency in an aqueous solution, when waste gas including diluted nitrogen oxides is directly used as a reactant during nitrogen oxide conversion, a nitrogen compound to be desired may not be obtained from the nitrogen oxides, and only when a high-concentration nitrogen oxide obtained by purifying the waste gas is used as a reactant, the nitrogen oxide conversion reaction may be performed.

Thus, after in-depth research, the present applicant has developed an ammonium nitrate manufacturing apparatus which does not require a reducing agent such as hydrogen or ammonia unlike a conventional selective reduction process, is economical and energy-efficient since the nitrogen oxide conversion reaction is performed at room temperature, shows an excellent nitrogen oxide conversion rate though the reactant includes a diluted nitrogen oxide, and since a diluted nitrogen oxide is directly converted into ammonium nitrate, does not require a separate waste gas purification process to simplify the process, and a method for manufacturing ammonium nitrate using the apparatus.

The ammonium nitrate manufacturing apparatus according to the present disclosure, which is an apparatus for manufacturing ammonium nitrate from a diluted nitrogen oxide, includes: a cathode; an anode which is arranged to be opposite to and spaced apart from the cathode; and an electrolyte placed between the anode and cathode, wherein the cathode and the anode are independently of each other gas diffusion electrodes including: a porous substrate; metal organic frameworks (MOFs) dispersed in the porous substrate; and a metal catalyst placed on one surface of the porous substrate.

The ammonium nitrate manufacturing apparatus may be a flow battery for converting nitrogen oxides. When electric energy is applied to the ammonium nitrate manufacturing apparatus, oxidation and reduction reactions occur in an anode and a cathode, respectively, and thus, nitrogen oxides causing air pollution may be converted into industrially high value-added ammonium nitrate.

The nitrogen oxide refers to a compound including nitrogen and oxygen such as NO, NO₂, NO₃, N₂O₃, N₂O₄, and N₂O₅, or a mixture thereof and may be represented by NOₓ, and more specifically, the nitrogen oxide may refer to nitrogen monoxide (NO).

The ammonium nitrate manufacturing apparatus provided with an anode and a cathode which are independently of each other a gas diffusion electrode containing a porous substrate, a metal organic framework, and a metal catalyst may produce ammonium nitrate with a high production rate from a nitrogen oxide, though a diluted nitrogen oxide including a low-concentration nitrogen oxide is used as a reactant. Thus, as mass transfer efficiency to an electrode is improved, only a nitrogen oxide is selectively adsorbed among reactants introduced to the ammonium nitrate manufacturing apparatus, and as the adsorbed nitrogen oxide is rapidly diffused to the surface of the metal catalyst, the nitrogen oxide conversion efficiency may be significantly improved.

In an exemplary embodiment, the metal organic frameworks (MOFs) may be dispersed inside the pores and on the surface of the pores of the porous substrate. The metal organic frameworks may be evenly dispersed inside the pores and on the surface of the pores of the porous substrate to greatly improve the specific surface area of the gas diffusion electrode. In addition, the metal organic frameworks may selectively adsorb only the nitrogen oxide included at a low concentration in the reactant. Since the nitrogen oxide in the reactant is effectively adsorbed into the pores of the porous substrate, nitrogen oxide conversion efficiency may be improved.

The metal organic frameworks (MOFs) may include coordinatively unsaturated metal sites (CUMSs) to further improve the adsorption performance n particular nitrogen oxides such as NO.

More specifically, adsorption energy to the nitrogen oxide of the metal catalyst may be higher than that of the metal organic framework. When the nitrogen oxide adsorption energy of the metal catalyst is lower than that of the metal organic framework, the nitrogen oxide adsorbed on the metal organic framework is not easily diffused to the metal catalyst, so that the nitrogen oxide conversion efficiency is lowered and internal nitrogen oxide accumulates in the pores of the porous substrate to cause pore occlusion. Thus, it is favorable that the nitrogen oxide adsorption energy of the metal catalyst is higher than the nitrogen oxide adsorption energy of the metal organic framework, since the nitrogen oxide may be rapidly diffused from the metal organic framework to the metal catalyst.

In a specific example, the metal organic framework may include one or more selected from the group consisting of UIO-66, HKUST, MOF-74, ZIF-8, and ZIF-67, and preferably may include UIO-66, ZIF-8, or a combination thereof. Since the metal organic framework may selectively adsorb the nitrogen oxide while having lower surface adsorption energy for the nitrogen oxide than that for the metal catalyst, the adsorbed nitrogen oxide may be rapidly transferred to the metal catalyst.

In a specific example, the metal organic framework particles may have an average size of 10 nm to 600 nm, 50 nm to 500 nm, 100 nm to 400 nm, or 200 nm to 300 nm. When the metal organic frameworks have the above size range, the specific surface area of the gas diffusion electrode including it may be further improved, which is thus favorable, but the present disclosure is not limited to the average size of the metal organic framework particles.

Specifically, the gas diffusion electrode may include micropores. The micropores refer to pores having a size of 2 nm or less, as defined by International Union of Pure and Applied Chemistry (IUPAC). Since the gas diffusion electrode having developed micropores have a significantly improved specific surface area, a larger amount of nitrogen oxide may be adsorbed on the anode and the cathode.

In an exemplary embodiment, the cathode and the anode may include different types of metal catalysts. Specifically, the cathode may contain copper as a metal catalyst, and the anode may contain nickel (Ni), nickel oxide (NiO), or a combination thereof as the metal catalyst.

The ammonium nitrate manufacturing apparatus in which the anode and the cathode contain the metal catalyst of the above combination oxidizes the nitrogen oxide in the anode to convert it into a nitrate ion and reduces the nitrogen oxide in the cathode to convert it into an ammonium ion. Ammonium nitrate may be obtained from the ammonium ion and the nitrate ion produced in each electrode.

In a specific example, the cathode metal catalyst may be copper nanoparticles, and more specifically, the copper nanoparticles may have one or more shapes selected from nanoplate, nanosphere, nanowire, hollow nanosphere, and nanotube, and preferably, may include a one-dimensional copper nanowire which may improve the nitrogen oxide conversion efficiency and selectivity for an ammonium ion according to a combination of the metal organic frameworks and the porous substrate.

More specifically, an aspect ratio of the copper nanowire may be 50 to 500, 100 to 400, 150 to 300, or 150 to 250, but the present disclosure is not limited thereto.

The anode may contain nickel (Ni), nickel oxide (NiO), or a combination thereof as the metal catalyst, and preferably may include heterojunction catalyst containing nickel (Ni) and nickel oxide (Ni).

The heterojunction catalyst including nickel and nickel oxide has a high adsorption force for HNO₂ which is a reaction intermediate during a nitrogen oxide oxidation reaction and may significantly lower energy barrier required to convert nitrogen oxide into nitrate ion. In particular, since the heterojunction catalyst causes a reaction in which a nitrogen oxide is converted into HNO₂ which is a reaction intermediate to proceed spontaneously unlike a single catalyst including nickel and nickel oxide, nitrogen oxide conversion performance is improved, and selectivity for a nitrate ion, in particular, NO₃ is excellent.

In an example, the porous substrate may be used without limitation as long as it is a porous substrate having conductivity, and specifically, may include a carbon body. Specifically, the carbon body may be one or more selected from the group consisting of carbon black, graphene, carbon nanotubes, glassy carbon, carbon fiber, and carbon paper, and preferably, may be carbon paper, but the present disclosure is not limited thereto.

In a specific example, the pores included in the porous substrate may have an average particle diameter of 10 nm to 1000 nm, 30 nm to 700 nm, or 50 nm to 500 nm. When the pores of the porous substrate have the average particle diameter within the range, micropores may be developed without pore blockage by the metal organic frameworks, but the present disclosure is not limited to the average particle diameter of the pores included in the porous substrate.

In an exemplary embodiment, the apparatus may further include a first fluid housing part placed on one surface of the cathode; and a second fluid housing part placed on one surface of the anode. A first fluid housing part and a second fluid housing part may be arranged on a surface opposite to the surface on which the metal catalyst is placed in the anode and the cathode, respectively.

The first fluid housing part may include a first fluid inlet and a first fluid outlet on one side, and the second fluid housing part may include a second fluid inlet and a second fluid outlet on the other side. The first fluid housing part and the second fluid housing part may be provided in an internal space which houses a fluid.

The reactant containing the nitrogen oxide may be continuously supplied to the cathode and the anode, respectively, through the fluid inlet included in each fluid housing part. The nitrogen oxide in the reactant is converted into ammonium nitrate through an electrochemical reaction, and the reactant from which the nitrogen oxide has been removed may be discharged through the first fluid outlet and the second fluid outlet.

The electrolyte may be housed in the electrolyte housing part placed between the anode and the cathode and brought into contact with at least a part of the anode and the cathode. Preferably, the electrolyte is arranged to be in contact with the metal catalyst of the anode and the cathode, and a proton or an electron is effectively supplied to the surface of the metal catalyst on which a nitrogen oxide conversion reaction occurs, so that nitrogen oxide conversion efficiency may be improved.

As an example, the electrolyte housing part includes an electrolyte inlet and an electrolyte outlet on one side, and the electrolyte may continuously flow between the anode and the cathode. As the electrolyte is continuously supplied, ammonium nitrate is also continuously discharged through the electrolyte outlet, and thus, nitrogen oxide conversion efficiency may be further improved.

In a specific example, the electrolyte may include one or more selected from the group consisting of potassium hydrogen carbonate (KHCO₃), potassium sulfate (K₂SO₄), and potassium chloride (KCl), but the present disclosure is not limited to the specific types of the electrolytes.

In a first embodiment of the present disclosure, the ammonium nitrate manufacturing apparatus may further include a separator placed between the anode and the cathode. The anode and the cathode may be separately housed in each chamber by the separator.

As the separator, any material having excellent durability and low gas permeability but high ion conductivity may be used, and as an example, the material may include a polymer separator such as cellulose acetate, nitrocellulose, cellulose ester, polysulfone (PS), polyethersulfone (PES), polyacrylonitrile (PAN), polyamide (PA), polyimide (PI), polyethylene (PE), polypropylene (PP), polytetrafluoroethylene (PTFE), polyvinylidene fluoride (PVDF), and polyvinyl chloride (PVC), but the present invention is not limited thereto.

Otherwise, in a second embodiment of the present disclosure, the ammonium nitrate manufacturing apparatus does not include a separator, and the anode, the cathode, and the electrolyte may be housed in a single chamber. Since the anode, the cathode, and the electrolyte are housed in a single chamber without including the separator, resistance applied to the ammonium nitrate manufacturing apparatus by the separator may be significantly lowered.

In a third embodiment of the present disclosure, the ammonium nitrate manufacturing apparatus may include the anode, the cathode, and the electrode housed in a single chamber without including the separator, and simultaneously, further include a flow path which connects the first fluid outlet and the second fluid inlet. Unlike the manufacturing apparatuses of ammonium nitrate of the first embodiment and the second embodiment in which the reactant is supplied to the anode and the cathode through the first fluid inlet and the second fluid inlet, respectively, the ammonium nitrate manufacturing apparatus of the third embodiment is provided with the flow path which connects the first fluid outlet and the second fluid inlet and may supply the reactant only to the cathode.

The cathode supplied with the reactant may produce an ammonium ion by performing an electrochemical conversion reaction of a nitrogen oxide. The reactant including an unreacted nitrogen oxide which does not participate in the reaction in the cathode may be transferred to the anode through the flow path. The unreacted nitrogen oxide moving to the anode may produce a nitrate ion through the electrochemical conversion reaction. The amount of the nitrogen oxide which does not participate in the reaction may be minimized to efficiently consume the nitrogen oxide which is the main cause of air pollution. Thus, since a large amount of ammonium nitrate may be produced even with the same amount of nitrogen oxide, the nitrogen oxide may be effectively removed together with improved production efficiency of ammonium nitrate, thereby improving air pollution.

In another general aspect, a method for manufacturing ammonium nitrate using the ammonium nitrate manufacturing apparatus described above is provided. In describing the method for manufacturing ammonium nitrate according to the present disclosure, since the material, the structure, the shape or size, and the like of the ammonium nitrate manufacturing apparatus are the same as or similar to those described above, all of the above descriptions are included.

The method for manufacturing ammonium nitrate according to the present disclosure includes: (S10) supplying a reactant containing a nitrogen oxide to a cathode and an anode of the ammonium nitrate manufacturing apparatus described above to produce an ammonium ion in the cathode and produce a nitrate ion in the anode; and (S20) reacting the nitrate ion and the ammonium ion to manufacture ammonium nitrate.

Even when the diluted nitrogen oxide is used as the reactant, excellent nitrogen oxide conversion efficiency is shown without the need to use a high-concentration nitrogen oxide obtained by extracting the nitrogen oxide included in mixed gas through a separate purification process as the reactant, and thus, the process may be simplified. More favorably, nitrogen oxide-containing waste gas emitted in a process of burning coal, fuel, and the like throughout the industry may be directly used as a reactant.

In a specific example, the content of nitrogen oxide in the reactant may be 50 ppm or less, 45 ppm or less, 40 ppm or less, 35 ppm or less, 30 ppm or less, 25 ppm or less, or 20 ppm or less. The lower limit may be 1 ppm or more, 3 ppm or more, 5 ppm or more, or 10 ppm or more, or may be a value between the numerical ranges.

In an exemplary embodiment, (S10) may be performed by supplying reactant to the cathode and the anode, respectively.

Otherwise, as a favorable example, the reactant may be supplied only to the cathode. When the reactant is supplied only to the cathode, (S10) may include: (S11) supplying a reactant containing a nitrogen oxide to the cathode to produce an ammonium ion; and (S12) supplying a reactant containing an unreacted nitrogen oxide discharged from the cathode to the anode to produce a nitrate ion.

The reactant is supplied to the cathode to perform an electrochemical conversion reaction of a nitrogen oxide, the remaining unreacted nitrogen oxide is transferred to the anode, and an electrochemical conversion reaction of the unreacted nitrogen oxide is performed in the anode, thereby minimizing the amount of the nitrogen oxide which does not participate in the reaction.

The reactant from which the nitrogen oxide has been removed through (S10) may be discharged outside of the ammonium nitrate manufacturing apparatus. The nitrogen oxide causing air pollution may be removed to improve air pollution.

(S20) may be performed in the electrolyte of the ammonium nitrate manufacturing apparatus. The nitrate ion and the ammonium ion produced through (S10) may move to the electrolyte placed between the anode and the cathode to manufacture ammonium nitrate. The manufactured ammonium nitrate may be discharged through an electrolyte outlet and obtained.

Since the ammonium nitrate may be directly manufactured in the electrolyte without the need to provide a separate space where ammonium nitrate is manufactured from the nitrate ion and the ammonium ion formed in the anode and the cathode, volume occupied by the ammonium nitrate manufacturing apparatus may be decreased and industrially high value-added ammonium nitrate may be manufactured more efficiently from a nitrogen oxide.

Hereinafter, the present invention will be described in more detail by the examples.

### (Manufacturing Example 1) Manufacture of UIO-66/CP

In order to manufacture metal organic frameworks, 1.06 g of zirconium (IV) chloride (ZrCl₄) and 0.76 g of terephthalic acid were dissolved in 60 mL of dimethylformamide (DMF) with stirring until a uniform solution was obtained. Thereafter, the prepared solution was transferred to an autoclave containing 100 mL of Teflon and heated at 120° C. for 24 hours. After the reaction, the temperature was cooled to room temperature to recover a precipitate, and centrifugation was performed several times in ethanol and washing was performed to manufacture UIO-66.

As a porous substrate, carbon paper (CP) having a size of 15 mm×15 mm was prepared. First, 10 mg of UIO-66 was dispersed in 500 μl of ethanol under ultrasonic conditions to manufacture a MOFs ink. Thereafter, the MOFs ink was dripped onto one surface of the carbon paper, but before dripping the MOFs ink, the carbon paper was left until the solvent on the carbon paper was dried. The drying and dripping process was repeated until all catalyst ink was uniformly applied on the carbon paper. This was named UIO-66/CP.

### (Manufacturing Example 2) Manufacture of ZIF-8/CP

It was manufactured in the same manner as in Manufacturing Example 1, except that ZIF-8 was used instead of UIO-66. This was named ZIF-8/CP.

Specifically, 6.5 g of 2-methylimidazole and 3.0 g of Zn(NO₃)₂.6H₂O were dissolved in 80 ml of methanol and 40 mL of methanol, respectively. Vigorous stirring was performed while the Zn(NO₃)₂.6H₂O solution was slowly added to the 2-methylimidazole solution for 24 hours. Thereafter, after centrifugation with methanol several times, the product was dried under vacuum at 60° C. overnight to synthesize ZIF-8.

### (Manufacturing Example 3) Manufacture of ZIF-67/CP

It was manufactured in the same manner as in Manufacturing Example 1, except that ZIF-67 was used instead of UIO-66. This was named ZIF-67/CP.

Specifically, 2.5 g of 2-methylimidazole and 2.2 g of Co(NO₃)₂.6H₂O were dissolved in 60 ml of methanol and 30 ml of methanol, respectively. Vigorous stirring was performed while the Co(NO₃)₂.6H₂O solution was slowly added to the 2-methylimidazole solution for 24 hours. Thereafter, after centrifugation with methanol several times, the product was dried under vacuum at 60° C. overnight to synthesize ZIF-67.

### (Manufacturing Example 4) Manufacture of UIO-66/CP/CuNWs

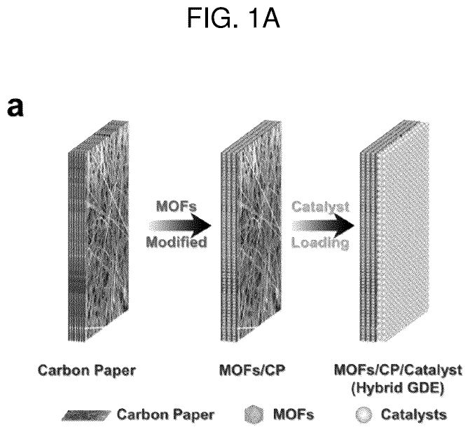

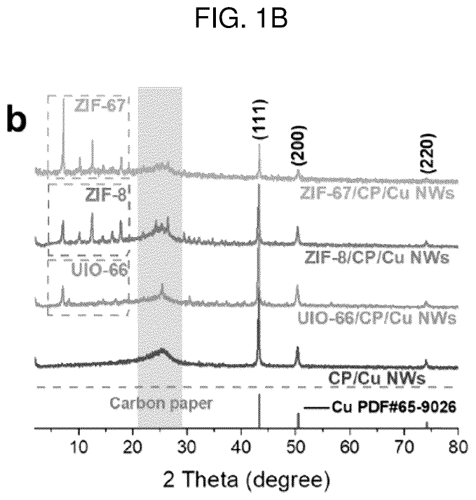

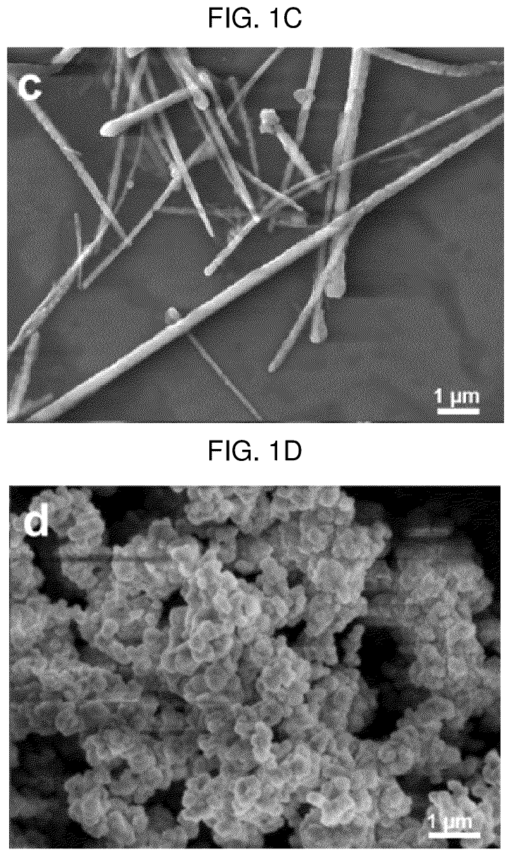

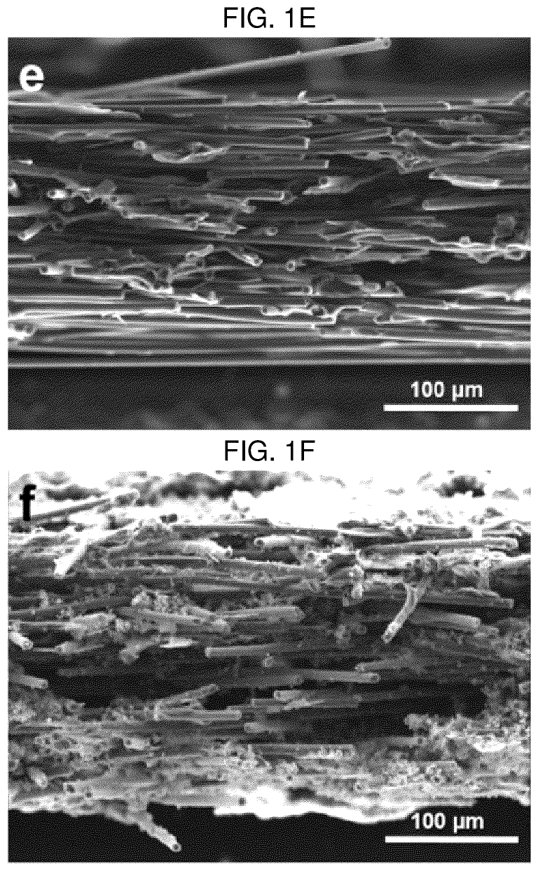

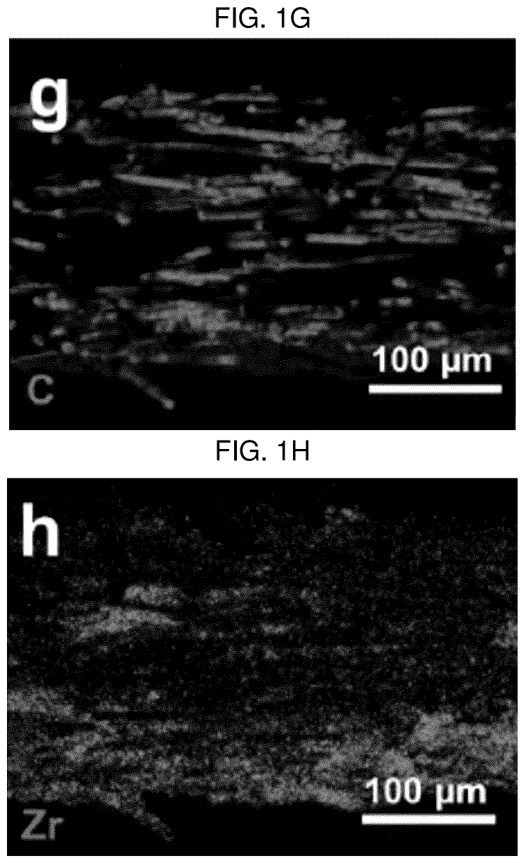

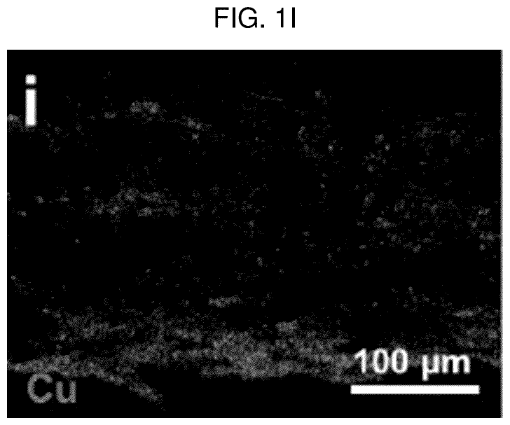

As shown in FIG. 1A, a metal catalyst was dripped onto one surface of the UIO-66/CP manufactured by the method of Manufacturing Example 1 to manufacture a gas diffusion electrode for a cathode. This was named UIO-66/CP/CuNWs.

In order to manufacture a metal catalyst, 41.5 mL of a 0.1 mol/L Cu(NO₃)₂ aqueous solution was mixed with 833 mL of a 10 M NaOH aqueous solution with vigorous stirring. 6.225 mL of ethylenediamine and 1.94 mL of a hydrazine aqueous solution (35 wt %) were added to the solution, and then the solution was placed in an oven and heated at 60° C. for 2 hours. Thereafter, agglomerated copper particles were washed by centrifugation with secondary distilled water several times to manufacture nanowire-shaped copper particles. The copper nanowire was stored in L-ascorbic acid including an ethanol solution in order to prevent oxidation.

The catalyst ink was dripped onto UIO-66/CP manufactured by the method of Manufacturing Example 1 to manufacture a gas diffusion electrode. The catalyst ink was manufactured by mixing 5 mg of a copper nanowire with an ethanol solution containing 5 wt % of nafion. Like the MOFs ink, the catalyst ink was dripped onto the other surface of the carbon paper onto which the MOFs ink was not dripped, the carbon paper was left until the solvent on the carbon paper was dried, and then the catalyst ink was dripped again. The drying and dripping process was repeated until the catalyst ink was all uniformly applied on the carbon paper, and then dried at 60° C. for 1 hour to manufacture a gas diffusion electrode for a cathode.

### (Manufacturing Example 5) Manufacture of ZIF-8/CP/CuNWs

A gas diffusion electrode for a cathode was manufactured by dripping a metal catalyst onto one surface of ZIF-8/CP of Manufacturing Example 2 by the method of Manufacturing Example 4. This was named ZIF-8/CP/CuNWs.

### (Manufacturing Example 6) Manufacture of ZIF-67/CP/CuNWs

A gas diffusion electrode for a cathode was manufactured by dripping a metal catalyst onto one surface of ZIF-67/CP of Manufacturing Example 3 by the method of Manufacturing Example 4. This was named ZIF-8/CP/CuNWs.

### (Manufacturing Example 7) Manufacture of CP/Cu NWs

A gas diffusion electrode for a cathode was manufactured in the same manner as in Manufacturing Example 4, except that the metal organic frameworks were not included. This was named CP/Cu NWs.

### (Manufacturing Example 8) Manufacture of UIO-66/CP/Cu NPs

A gas diffusion electrode for a cathode was manufactured in the same manner as in Manufacturing Example 4, except that copper nanoparticles were used instead of the copper nanowire. This was named UIO-66/CP/Cu NPs.

In order to synthesize copper nanoparticles, 25 mL of ethylene glycol solution including 1.0 g of polyethylene glycol (MW: 2050 or less) and 0.98 g of Cu(OH)₂ were heated at 80° C. for 30 minutes under stirring. 6.0 g of L-ascorbic acid was added to the mixed solution, and the solution was heated at 80° C. for 30 minutes under stirring. Thereafter, the L-ascorbic acid solution was poured into an electronic flask, the solution was maintained at 80° C. for 5 minutes, and the product was centrifuged and washed with ethanol several times to manufacture copper nanoparticles.

### (Manufacturing Example 9) Manufacture of UIO-66/CP/NiO Air500

A gas diffusion electrode for an anode was manufactured in the same manner as in Manufacturing Example 4, except that Nio nanoparticles were used as the metal catalyst instead of the copper nanowire. This was named UIO-66/CP/NiO Air500.

Specifically, in order to manufacture a NiO catalyst, 0.3 g of EDTA-2Na, 1.2 g of NiSO₄.6H₂O, and 0.3 g of urea were dissolved in 15 mL of deionized water, respectively. The NiSO₄.6H₂O solution was slowly added to the EDTA-2Na solution until the color of the mixed solution changed to a deep blue while stirring slowly. The urea solution was added dropwise to the mixed solution, stirring was performed for about 3 minutes, and the pH value was adjusted to 6. The manufactured solution was transferred to a 60 mL Teflon-lined autoclave, and stored at 180° C. for 4 hours. The reactor was cooled to room temperature, and then green powder was filtered, collected, and dried at 60° C. Thereafter, the green powder was annealed at 500° C. for 2 hours under an air atmosphere to manufacture NiO nanoparticles.

### (Manufacturing Example 10) Manufacture of UIO-66/CP/NiO Ar500

A gas diffusion electrode for an anode was manufactured in the same manner as in Manufacturing Example 9, except that the green powder was annealed under an argon (Ar) atmosphere. This was named UIO-66/CP/NiO Ar.

### (Manufacturing Example 11) Manufacture of UIO-66/CP/NiO HA500

A gas diffusion electrode for an anode was manufactured in the same manner as in Manufacturing Example 9, except that the NiO nanoparticles of Manufacturing Example 6 were further heat-treated for 10 minutes under argon gas flow conditions including 5 wt % of H₂ to manufacture a metal catalyst. This was named UIO-66/CP/NiO HA500.

### (Manufacturing Example 12) Manufacture of CP/NiO HA500

A gas diffusion electrode for an anode was manufactured in the same manner as in Manufacturing Example 9, except that the metal organic frameworks were not included. This was named CP/NiO Air500.

### (Manufacturing Example 13) Manufacture of CP/NiO Ar500

A gas diffusion electrode for an anode was manufactured in the same manner as in Manufacturing Example 10, except that the metal organic frameworks were not included. This was named CP/NiO Ar500.

### (Manufacturing Example 14) Manufacture of CP/NiO HA500

A gas diffusion electrode for an anode was manufactured in the same manner as in Manufacturing Example 11, except that the metal organic frameworks were not included. This was named CP/NiO HA500.

### (Example 1) Manufacture of UIO/GDEs/DC-DG

An ammonium nitrate manufacturing apparatus was manufactured by using the gas diffusion electrode manufactured by the method of Manufacturing Example 4 as a cathode and the gas diffusion electrode manufactured by the method of Manufacturing Example 11 as an anode.

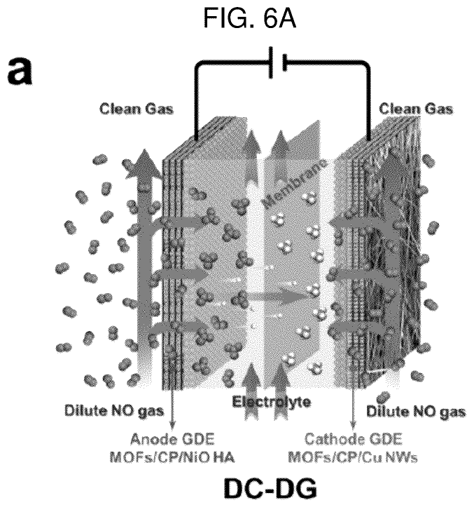

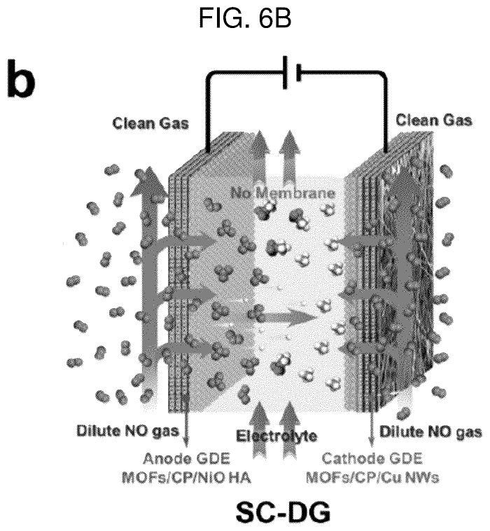

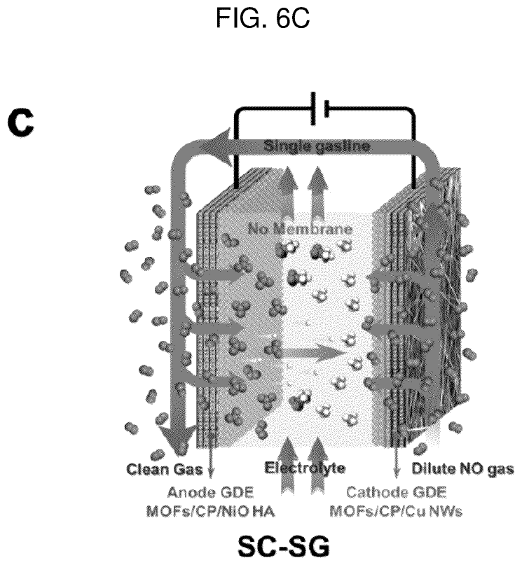

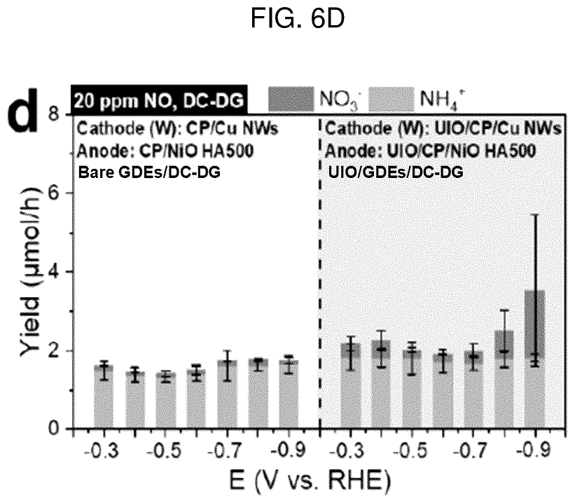

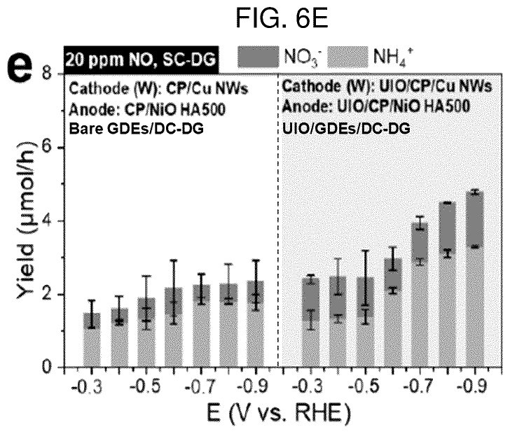

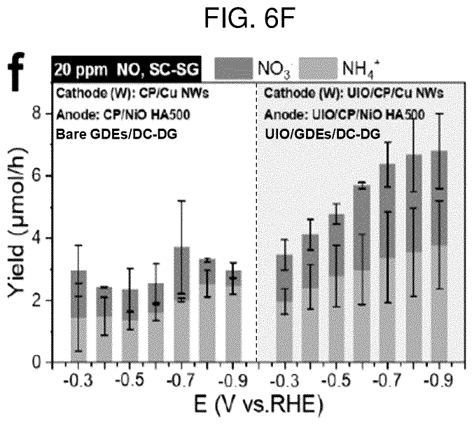

Specifically, as shown in FIG. 6A, in the ammonium nitrate manufacturing apparatus, an anion exchange membrane (Nafion 117) was arranged between the cathode of Manufacturing Example 1 and the anode of Manufacturing Example 8 to separate the anode and the cathode, which were housed in each chamber. The volumes of the anode chamber and the cathode chamber were 1 cm³ (1 cm×1 cm×1 cm), respectively. An electrolyte was supplied to the anode chamber and the cathode chamber while 10 ml of the electrolyte (0.5 M K₂SO₄) was circulated at a flow velocity of 2.0 ml/min using a peristaltic pump. Two gas chambers were installed on one surface of the anode and the cathode. A reactant was injected into the anode and the cathode through the gas chamber including a fluid inlet and a fluid outlet. As the reactant, No-containing gas was used, and the reactant was passed through the two gas chambers at a flow velocity of 250 mL/min to continuously supply the reactant to the anode and the cathode, thereby manufacturing a ammonium nitrate manufacturing apparatus. This was named UIO/GDEs/DC-DG (double chamber-double gas stream).

### (Example 2) Manufacture of UIO/GDEs/SC-DG

An ammonium nitrate manufacturing apparatus was manufactured in the same manner as in Example 1, except that the separator was not arranged between the cathode and the anode, as shown in FIG. 6B. This was named UIO/GDEs/SC-DG (single chamber-double gas stream).

### (Example 3) Manufacture of UIO/GDEs/SC-SG

An ammonium nitrate manufacturing apparatus was manufactured in the same manner as in Example 2, except that a flow path which connected a fluid outlet of the cathode gas chamber and the fluid inlet of the anode gas chamber was provided, and the reactant was supplied only to the cathode gas chamber, as shown in FIG. 6C. This was named UIO/GDEs/SC-SG (single chamber-single gas stream).

### (Comparative Example 1) Manufacture of Bare GDEs/DC-DG

An ammonium nitrate manufacturing apparatus was manufactured in the same manner as in Example 1, except that the gas diffusion electrode manufactured by the method of Manufacturing Example 7 was used as a cathode and the gas diffusion electrode manufactured by the method of Manufacturing Example 14 was used as an anode. This was named Bare GDEs/DC-DG (double chamber-double gas stream).

### (Comparative Example 2) Manufacture of bare GDEs/SC-DG

An ammonium nitrate manufacturing apparatus was manufactured in the same manner as in Example 2, except that the gas diffusion electrode manufactured by the method of Manufacturing Example 7 was used as a cathode and the gas diffusion electrode manufactured by the method of Manufacturing Example 14 was used as an anode. This was named bare GDEs/SC-DG (single chamber-double gas stream).

### (Comparative Example 3) Manufacture of bare GDEs/SC-SG

An ammonium nitrate manufacturing apparatus was manufactured in the same manner as in Example 3, except that the gas diffusion electrode manufactured by the method of Manufacturing Example 7 was used as a cathode and the gas diffusion electrode manufactured by the method of Manufacturing Example 14 was used as an anode. This was named Bare GDEs/SC-SG (single chamber-single gas stream).

### Measuring Equipment

X-ray diffraction (XRD) analysis was performed using a SmartLab model available from Rigaku.

As a scanning electron microscope (SEM), a SU8600 product available from Hitachi was used, and energy-dispersive spectroscopic (EDS) analysis was performed using the product.

X-ray photoelectron spectroscopic (XPS) analysis used K-alpha XPS equipment available from Thermo Scientific using monochromatic Al-Kα as an X-ray source.

As a transmission electron microscope (TEM), JEM-1400 (JEOL Ltd., Japan) was used, and energy dispersive X-ray microanalysis (EDX) analysis was performed using it.

NO electrochemical conversion reaction performance was evaluated using chronoamperometry (CA), and potential applied to a working electrode was re-adjusted based on a reversible hydrogen electrode (RHE) by the following Equation 1: In addition, a NO concentration in the reactant was controlled while the concentration of NO gas flowing at a flow velocity of 250 mL/min was changed using a mass flow rate controller.

E_{RHE}=E_{Ag/Agcl}+0.197 V+0.0592×pH [Equation 1]

### (Experimental Example 1) Analysis of Cathode Characteristics

In order to analyze the crystal structure of the cathode, X-ray diffraction (XRD) analysis was performed, and the results are shown in FIG. 1B. In addition, for the surface analysis of the cathode, the surface and the cross section of the cathode were observed using a scanning electron microscope and are shown in FIGS. 1C to F, and element distributions were confirmed by EDS analysis and are shown in FIGS. 1G to 1I.

As shown in FIG. 1B, in the cathode of Manufacturing Example 7 (CP/Cu NWs), a large peak was observed around 25° corresponding to a (002) plane of graphitic carbon in carbon paper, and it was confirmed that there were peaks (PDF #65-9026) corresponding to (111), (200), and (220) planes of a copper nanowire at 43.3°, 50.4°, and 74.0°, respectively. Meanwhile, in the cathodes of Manufacturing Examples 4 to 6 including the metal organic frameworks (hereinafter, referred to as MOFs), an additional diffraction peak for each MOF was observed at 2.5° to 50°, in particular, 2.5° to 20°, as well as peaks for carbon paper and a copper nanowire observed in Manufacturing Example 5.

FIGS. 1C and 1D are scanning electron microscope images of copper nanowire and UIO-66 manufactured by the method of Manufacturing Example 4, respectively, and it was confirmed that the copper nanowire had a nanowire shape having an average particle diameter of 100 nm and an average length of 20 μm and UIO-66 had an octahedral shape having an average size of 200 nm. Though not shown in FIG. 1, it was confirmed that the copper nanoparticles manufactured by the method of Manufacturing Example 8 had a spherical shape having an average particle diameter of 300 nm. FIGS. 1E and 1F are scanning electron microscope images in which the cross sections of carbon paper and the cathode according to Manufacturing Example 1 were observed, respectively. Carbon paper formed a multifilament shape, and it was found that the cathode according to Manufacturing Example 4 had a hybrid structure in which UIO-66 and a copper nanowire were applied on a multifilament-shaped carbon paper.

FIGS. 1G to 1I show EDS analysis results of the cathode according to Manufacturing Example 4, in which FIG. 1G is an EDS element mapping image of carbon (C), FIG. 1H is an EDS element mapping image of zirconium (Zr), and FIG. 1I is an EDS element mapping image of copper (Cu). As a result of EDS analysis, carbon (C) and zirconium (Zr) included in UIO-66 were evenly distributed throughout the cathode. Thus, it was confirmed that MOFs were evenly dispersed inside the pores and on the surface of the pores of carbon paper. However, copper (Cu) was distributed mainly on one surface of the carbon paper. Thus, it was confirmed that the cathode had an optimal structure for a more efficient nitrogen oxide conversion reaction in which the MOFs effectively captured only a low-concentration nitrogen oxide introduced to the ammonium nitrate manufacturing apparatus and adsorbed the nitrogen oxide on the surface of the cathode and inside the pores, and the nitrogen oxide was transferred to the surface of the metal catalyst in contact with the electrolyte.

### (Experimental Example 2) Evaluation of Electrochemical NO Reduction Reaction Performance of Cathode

The electrochemical reduction reaction performance of the cathode was evaluated. The evaluation was performed using a potentiometer (Gamry Instruments Reference 600) in a flow battery equipped with a standard 3-electrode system. The flow battery used a cathode as a working electrode, a PT wire as a counter electrode, and Ag/AgCl (in 3M KCl) as a reference electrode. The working electrode and the counter electrode were separated by an anion exchange membrane (Nafion 117) and housed in a separate chamber, and the volume of each chamber was 1 cm³ (1 cm×1 cm×1 cm). An electrolyte was supplied to each chamber while 10 mL of the electrolyte (0.5 M K₂SO₄) was circulated at a flow velocity of 2.0 ml/min using a peristaltic pump.

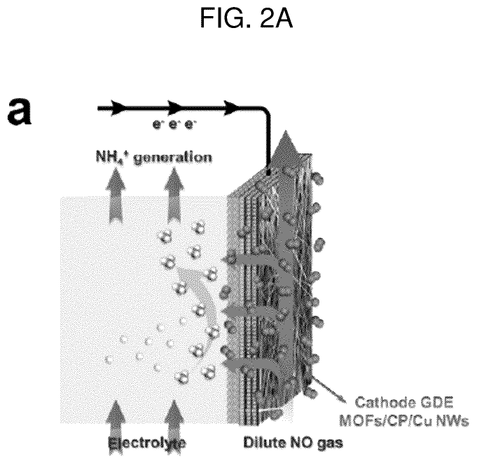

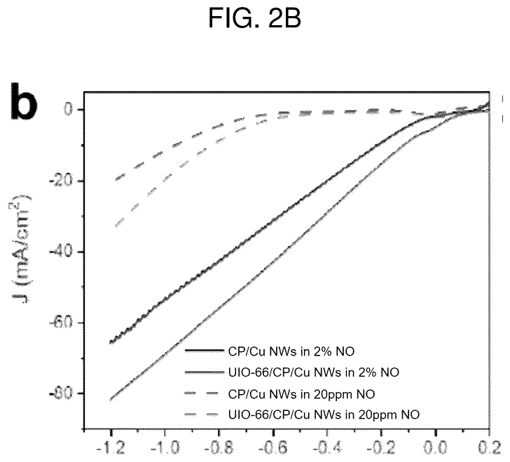

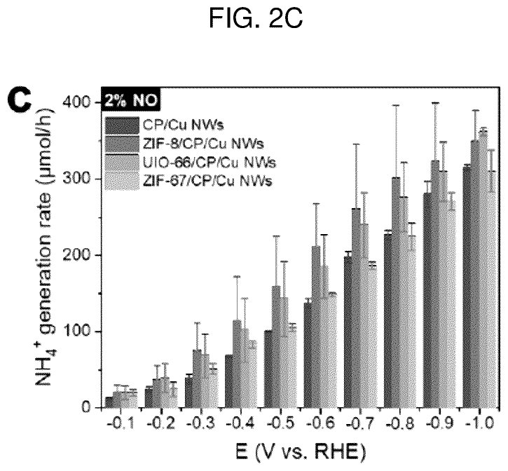

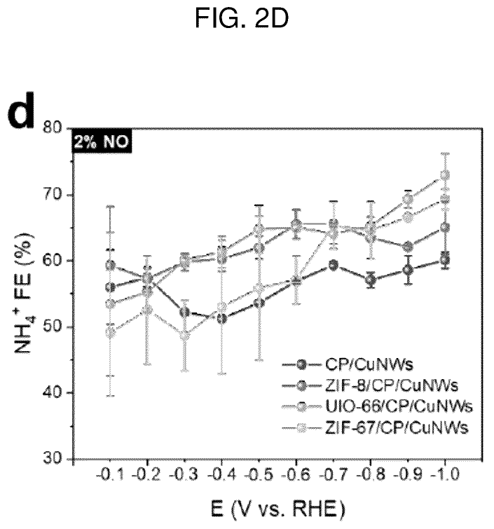

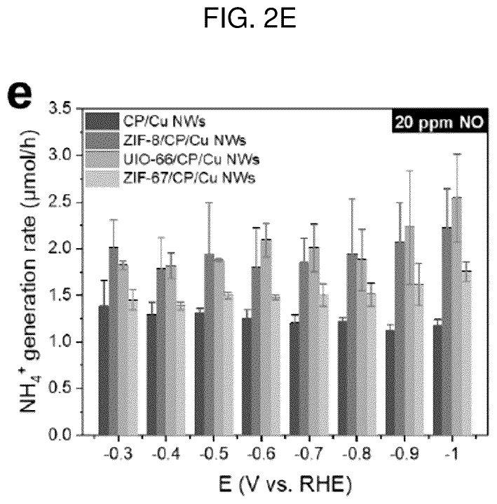

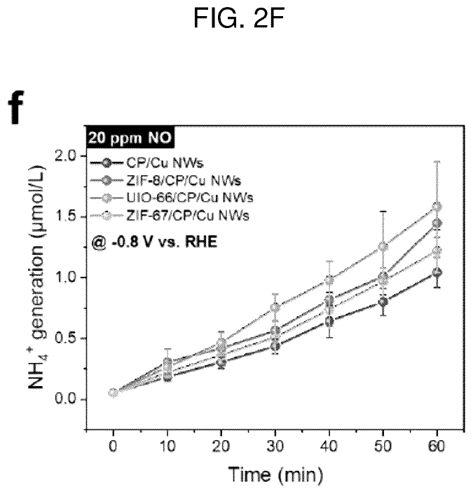

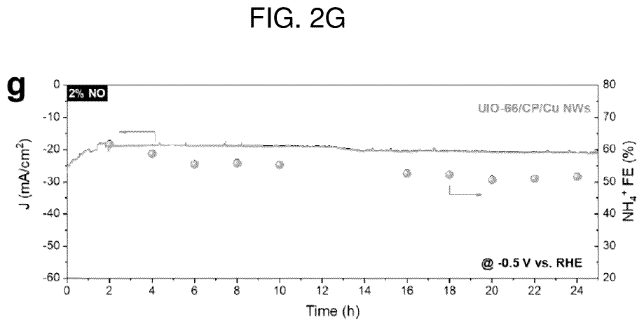

FIG. 2A is a schematic diagram showing a nitrogen oxide reduction reaction flow of a flow battery including the cathodes of Manufacturing Examples 4, 5, or 6. When the reactant including a nitrogen oxide was supplied to the flow battery, MOFs of the cathode may selectively adsorb the nitrogen oxide in the reactant. The adsorbed nitrogen oxide was rapidly diffused to the surface of the metal catalyst in contact with the electrolyte and converted the nitrogen oxide into an ammonium ion (NH₄⁺) by an electrochemical reduction reaction.

FIGS. 2B to 2G show results of measuring product selectivity depending on the content of nitric acid (NO) included in the reactant, and the experiment was performed by changing the concentration of NO gas which continuously flowed through a gas chamber at a flow velocity of 250 mL/min through a mass flow rate controller.

FIG. 2B is a graph in which the flow battery including each of the cathodes according to Manufacturing Example 4 (UIO-66/CP/Cu NWs) and Manufacturing Example 7 (CP/Cu NWs) was analyzed by linear sweep voltammetry (LSV) under the flow conditions of the reactant including 2% NO and 20 ppm of NO, respectively. The linear sweep voltammetry (LSV) was measured at a scan speed of 10 mV/s.

The cathode of Manufacturing Example 4 showed all high current reduction values regardless of the NO content, when compared with the cathode of Manufacturing Example 7. Specifically, when the current values of the cathode were compared under the voltage conditions of −1.2 V (vs. RHE), the current value of the cathode of Manufacturing Example 4 was higher than the current value of the cathode of Manufacturing Example 7 by 15.7 mA/cm² under 2% NO flow conditions, and the current value of the cathode of Manufacturing Example 4 was higher than the current value of the cathode of Manufacturing Example 7 by 13.8 mA/cm² under 20 ppm of NO flow conditions. Thus, it was proven that the cathode of Manufacturing Example 4 including MOFs was able to effectively adsorb NO even under a low-concentration NO gas flow and diffuse the adsorbed NO gas to the surface of the metal catalyst.

FIGS. 2C and 2D are graphs in which the production rate and the Faradaic efficiency of an ammonium ion (NH₄⁺) were measured when the content of NO gas in the reactant was 2%, respectively, and FIGS. 2E and 2F are graphs in which the production rate of an ammonium ion (NH₄⁺) when the content of NO gas in the reactant was 20 ppm and the production rate of an ammonium ion (NH₄⁺) to time for NORR under −0.8 V (vs. RHE) conditions were measured, respectively. Referring to FIGS. 2C to 2F, the cathodes of Manufacturing Examples 4 to 6 containing MOFs showed better ammonium ion production rates and yields than the cathode of Manufacturing Example 7 which did not include MOFs, overall, regardless of NO concentration.

In particular, when the NO concentration was 20 ppm, the difference became more noticeable. In −0.9 V (vs. RHE) to −1.0 V (vs. RHE), the ammonium ion production rates of the cathodes of Manufacturing Example 4 (UIO-66/CP/Cu NWs) and Manufacturing Example 5 (ZIF-8/CP/Cu NWs) were about twice as high as that of the cathode of Manufacturing Example 7 (CP/Cu NWs). In addition, when the NO conversion reaction was performed for 60 minutes, the cathode of Manufacturing Example 4 (UIO-66/CP/Cu NWs) showed the highest ammonium ion production rate, and the cathode of Manufacturing Example 7 (CP/Cu NWs) showed the lowest ammonium ion production rate. Thus, it was confirmed that the cathode containing MOFs was able to maximize the nitrogen oxide adsorption effect, when the reactant contained the nitrogen oxide at a low concentration.

In addition, though not shown in FIGS. 2B to 2F, the current value according to LSV, the ammonium ion (NH₄⁺) production rate, and the Faradaic efficiency for an ammonium ion (NH₄⁺) of the cathode of Manufacturing Example including a copper nanowire were all higher than those of the cathode of Manufacturing Example 8 including copper nanoparticles, in a 2% NO gas flow. Thus, it was found that the one-dimensional copper nanowire is more favorable for the electrochemical reduction reaction of a nitrogen oxide than the copper nanoparticles.

Besides, as shown in FIG. 2G, the cathode of Manufacturing Example 4 (UIO-66/CP/Cu NWs) stably converted the nitrogen oxide into the ammonium ion for 24 hours. Specifically, since a reduction current density was maintained for 24 hours at a level of 20 mA/cm², and the Faradaic efficiency for the ammonium ion was decreased only by about 14% for 24 hours and was more than 50% even after 24 hours, it was confirmed that the nitrogen oxide conversion reaction stably proceeded.

### (Experimental Example 3) Evaluation of Adsorption Characteristics of Gas Diffusion Electrode

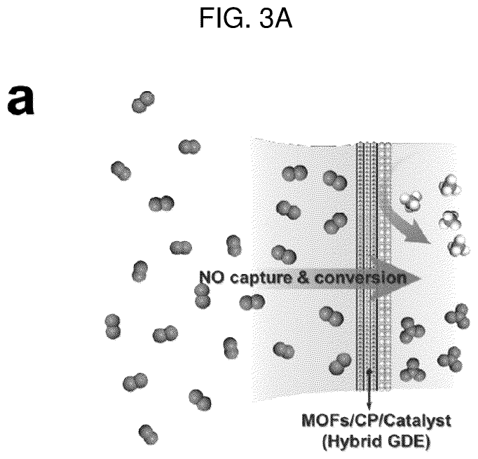

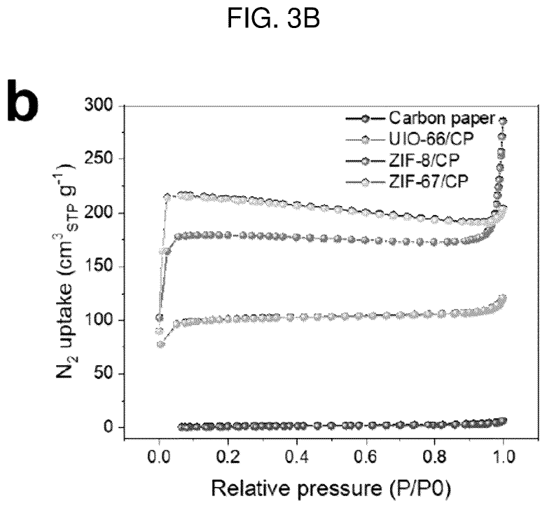

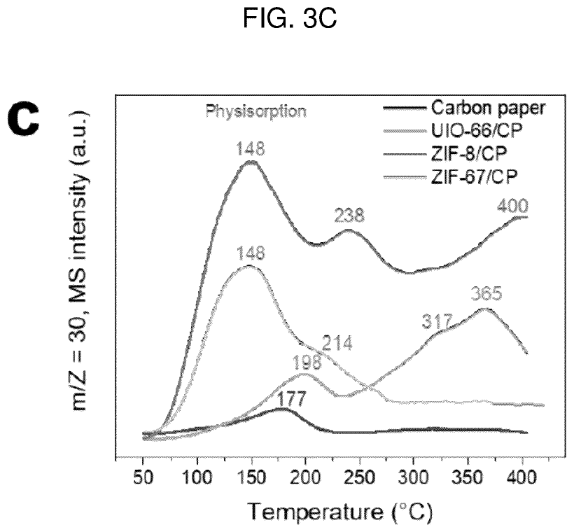

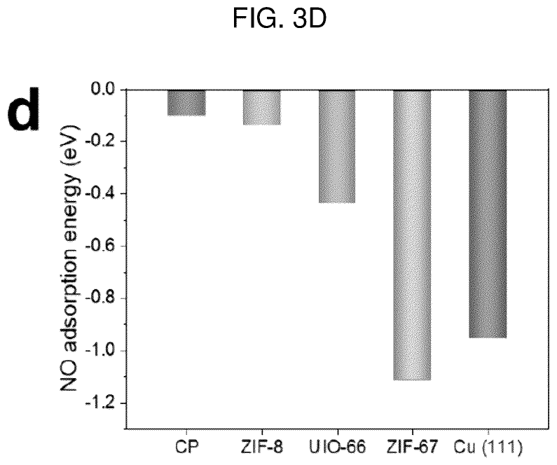

As shown in FIG. 3A, when a large amount of nitrogen oxide was adsorbed on the gas diffusion electrode and the nitrogen oxide was present at a high concentration on the surface of the metal catalyst, the nitrogen oxide conversion efficiency was improved to improve nitrogen oxide conversion performance. Thus, the nitrogen oxide adsorption characteristics of the gas diffusion electrode were evaluated.

First, the specific surface area of the gas diffusion electrode was measured according to the Brunauer-Emmett-Teller (BET) method and is shown in FIG. 3B. The BET specific surface area was measured in accordance with the method of ISO 9277:2022, and nitrogen gas adsorption and desorption amounts of the gas diffusion electrode on which a metal catalyst ink was not applied were measured under a liquid nitrogen temperature (77 K) using BELCAT II from BEL Japan.

Referring to FIG. 3B, the nitrogen adsorption/desorption isotherms of the gas diffusion electrodes of Manufacturing Example 1 (UIO-66/CP), Manufacturing Example 2 (ZIF-8/CP), and Manufacturing Example 3 (ZIF-67/CP) including MOFs all showed the adsorption form of Type I defined by International Union of Pure and Applied Chemistry (IUPAC), and were confirmed to include a large amount of micropores having a diameter of 2 nm or less. The gas diffusion electrodes of Manufacturing Examples 1 to 3 including a large amount of micropores had significantly improved specific surface areas as compared with common carbon paper. Since MOFs were present inside the pores and on the surface of the pores of the porous carbon paper to develop micropores and significantly improve the specific surface area of the gas diffusion electrode, a large amount of nitrogen oxide was able to be adsorbed on the anode and the cathode.

The nitric acid adsorption ability of the gas diffusion electrode was measured by nitric acid-temperature programmed desorption (NO-TPD). In order to measure the nitric acid adsorption ability by the nitric acid-temperature programmed desorption, 0.1 g of a gas diffusion electrode sample was added to a reactor, which was heated to 300° C. under an Ar atmosphere, the temperature was maintained until the baseline of a thermal conductivity detector (TCD) was stabilized to remove nitrogen, oxygen, and other impurity gas which were physically adsorbed on the sample, and the temperature was cooled to room temperature (25° C.). Next, NO gas was continuously injected until the NO gas was adsorbed on the surface of the sample and reached a saturation state, and while the reactor was heated to 450° C. at a heating rate of 5° C./min, a signal change was recorded by a thermal conductivity detector (TCD).

As shown in FIG. 3C, though the carbon paper had very weak nitric acid adsorption ability, both the peak intensity and the temperature at which the peak occurred in the gas diffusion electrodes of Manufacturing Examples 1 to 3 including MOFs increased, adsorption energy was improved, sites for nitric acid adsorption increased, and thus, it was found that NO adsorption performance was improved. In the gas diffusion electrodes of Manufacturing Example 2 (ZIF-8/CP) and Manufacturing Example 3 (ZIF-67/CP), a desorption peak was observed at 148° C., which resulted from NO which was physically adsorbed on the gas diffusion electrodes. However, in the gas diffusion electrode of Manufacturing Example 1 (UIO-66/CP), the desorption peak was not observed at 148° C. or lower and observed at 148° C. or higher, and it was confirmed that NO was chemically adsorbed on the gas diffusion electrode.

As the nitric acid adsorption capacity of the gas diffusion electrode is higher, a NO concentration in an interface between NO gas, the gas diffusion electrode, and an electrolyte, that is, an interface between gas-solid-liquid may be improved. However, when NO is too strongly bound to MOFs of the gas diffusion electrode, a process of diffusing NO adsorbed by MOFs to the metal catalyst may be delayed to lower NO conversion efficiency. In order to evaluate NO transfer efficiency, the NO adsorption energies of carbon paper (CP), UIO-66, ZIF-8, and ZIF-67 with copper were compared. The NO adsorption energy was calculated by density functional theory (DFT). The adsorption energy of NO adsorbed on the upper portion of a carbon atom, the bridge, and the hollow portion of a multilayer graphene model was calculated in the carbon paper, the adsorption energy of NO adsorbed on the upper portion of a zinc atom, the center of a 4-imidazole ring, the center of a 6-imidazole ring, the upper portion of an imidazole ring, and the center of a hexahedral structure was calculated in ZIF-8, and in ZIF-67 having a structure similar to ZIF-8, the adsorption energy of NO on the same portions as ZIF-8 was calculated. The adsorption energy of NO adsorbed on the upper portion of a zirconium atom, the upper portion of a benzene ring, and the center of a framework was calculated in UIO-66. The NO adsorption energy on a Cu (111) plane was estimated and calculated in copper. The portion on which NO was the most stably adsorbed was the upper portion of the cobalt atom of ZIF-67, the center of the 6-imidazole ring of ZIF-8, the upper portion of the benzene ring of UIO-66, the hollow portion of the carbon paper, and the bridge portion of the Cu (111) plane, respectively, and the surface energy values in these portions are shown in FIG. 3D.

Referring to FIG. 3D, the NO adsorption energy of ZIF-67 was higher than the adsorption energy of the Cu (111) plane. Though ZIF-67 was able to strongly adsorb NO, NO adsorbed on ZIF-67 was not able to be diffused to the copper catalyst, and thus, it suggests that the electrochemical conversion reaction efficiency of NO was significantly decreased. However, since the NO adsorption energies of UIO-66 and ZIF-8 were lower than the NO adsorption energy of the Cu (111) plane, NO adsorbed with MOFs was able to be rapidly diffused to the copper catalyst. Since UIO-66 showed higher NO adsorption energy than ZIF-8, UIO-66 was able to diffuse NO to the copper catalyst well and simultaneously provide a higher NO adsorption capacity than ZIF-8. Since the carbon paper had significantly low NO adsorption energy, it was found that when diluted NO gas including low-concentration NO was used as a reactant, NO adsorption and conversion performance would be significantly low.

### (Experimental Example 4) Analysis of Anode Characteristics

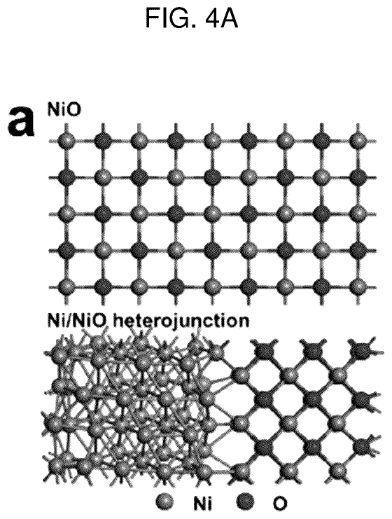

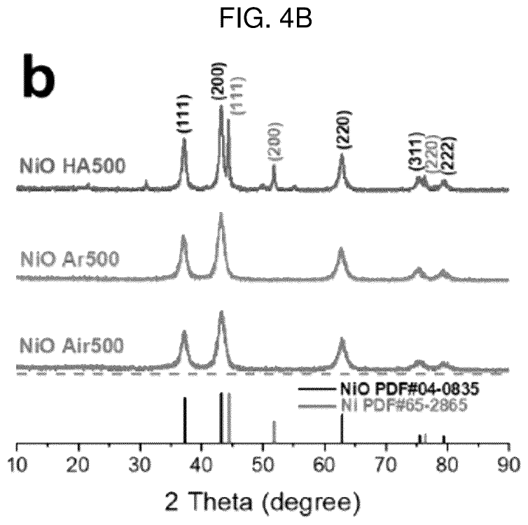

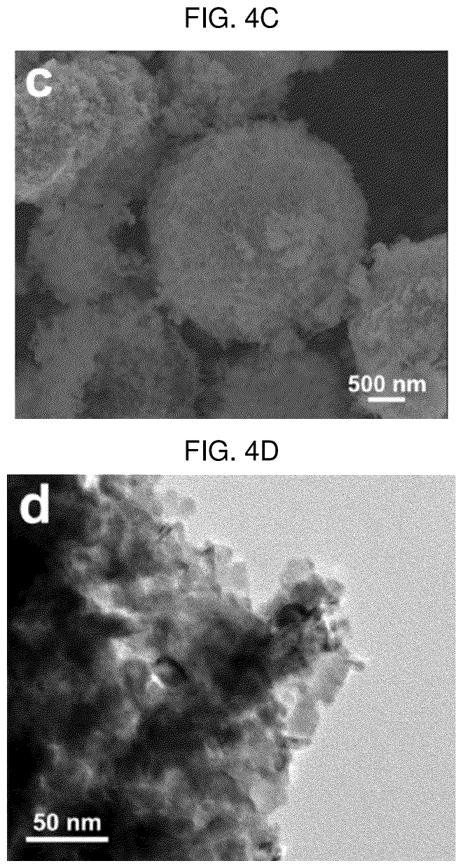

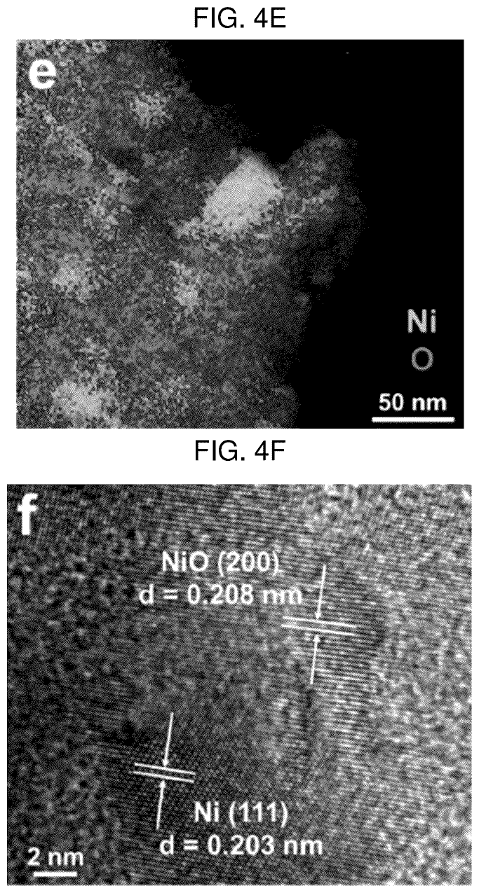

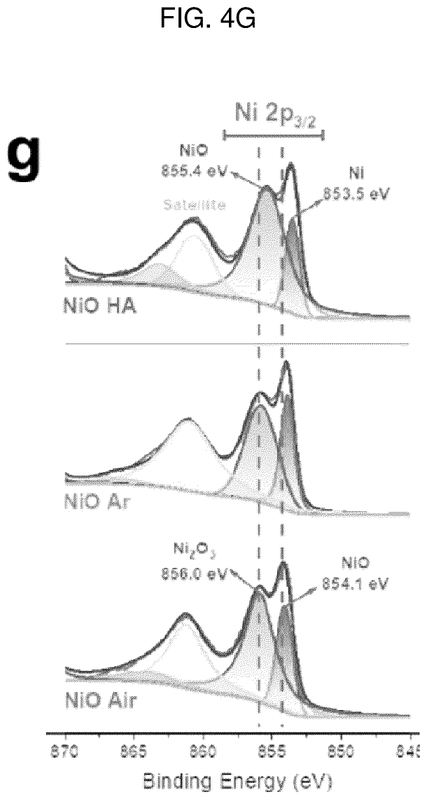

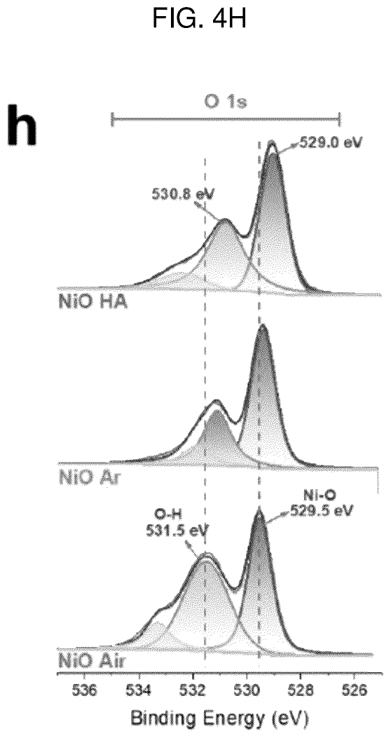

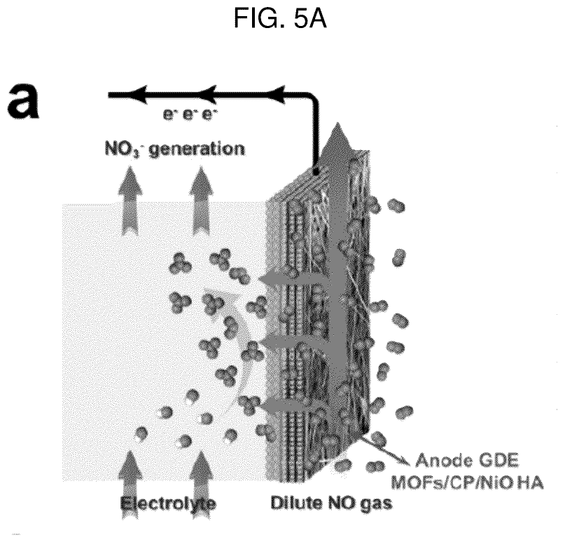

For the crystal structure analysis of the metal catalyst included in the anode, X-ray diffraction (XRD) was performed and is shown in FIG. 4B. They are XRD spectra of the metal catalysts manufactured by the methods according to Manufacturing Example 9 (NiO Air 500), Manufacturing Example 10 (NiO Ar 500), and Manufacturing Example 11 (NiO HA 500).

In the metal catalysts of Manufacturing Examples 9 and 10, since the same peak as that specified in “Cubic NiO (PDF #04-0835)” was observed, it was confirmed that a monocrystalline NiO was included, and since main peaks were observed at 37.3°, 43.3°, and 62.9°, it was found that (111), (200), and (220) planes for NiO existed. However, in the metal catalyst of Manufacturing Example 11 which was manufactured by annealing NiO under the mixed gas conditions of H₂ gas and Ar gas, the same peak as that specified in “Cubic Ni (PDF #65-2865)” was observed at 44.5°, 51.8°, and 76.4°, as well as the peak for NiO, and it was found that (111), (220), and (220) planes of Ni existed.

Thus, as shown in FIG. 4A, it was confirmed that the metal catalysts manufactured by the methods of Manufacturing Examples 9 and 10 included a NiO single phase, but the metal catalyst manufactured by the method of Manufacturing Example 11 was a Ni/NiO heterojunction catalyst including Ni and NiO.

In order to observe the surface structure and the element distribution of the metal catalysts, the metal catalysts were observed through a scanning electron microscope and a transmission electron microscope, and are shown in FIGS. 4C to 4F.

FIG. 4C is a scanning electron microscope image of the metal catalyst manufactured by the method of Manufacturing Example 11. It was confirmed that the metal catalysts had a nanospherical shape assembled with a nanosheet. Though not shown in FIG. 4, as a result of observing the cross section of the anode according to Manufacturing Example 4 through a scanning electron microscope, it was confirmed that the nanospherical-shaped metal catalyst was dispersed on one surface of the carbon paper, like the cathode.

FIG. 4D is a transmission electron microscope image of the metal catalyst manufactured by the method of Manufacturing Example 11, FIG. 4E is the TEM-EDX element mapping image of the metal catalyst manufactured by the method of Manufacturing Example 11, and FIG. 4F is a high-resolution transmission electron microscope image of the metal catalyst manufactured by the method of Manufacturing Example 11. It was found that the metal catalyst included nickel and an oxygen atom from the transmission electron microscope image and the TEM-EDX element mapping image. In the high-resolution transmission electron microscope image, since a lattice pattern having an interplanar distance of 0.203 nm was observed, it was confirmed that a Ni (111) plane existed, and also, since a lattice pattern having an interplanar distance of 0.208 nm was observed, it was confirmed that a NiO (200) plane existed. Thus, it was confirmed that a heterojunction catalyst in which nickel and nickel oxide coexisted was manufactured.

In order to analyze the chemical bonding state of the metal catalyst included in the anode, X-ray photoelectron spectroscopy (XPS) analysis was performed and the results are shown in FIGS. 4G and 4H. They are XPS spectra of the metal catalysts manufactured by the methods according to Manufacturing Example 9 (NiO Air), Manufacturing Example 10 (NiO Ar), and Manufacturing Example 11 (NiO HA), respectively.

Referring to FIG. 4G which shows a Ni 2p XPS spectrum, in the metal catalysts of Manufacturing Examples 9 and 10, a peak for nickel having an oxidation number of 2 in a binding energy of 854.1 eV and a peak for nickel having an oxidation number of 3 in a binding energy of 856.0 eV were observed, and thus, the main valence state of the nickel element was an oxidation state.

In comparison, in the metal catalyst of Manufacturing Example 11, the peak was shifted in a direction in which the binding energy was decreased by 0.6 eV from those of Manufacturing Examples 9 and 10, and a peak for nickel having an oxidation number of 0 at 853.5 eV and a peak corresponding to Ni having an oxidation number of 2 at 855.4 eV were observed. A red shift of the binding energy means that nickel metal having an oxidation number of 0 was formed.

The binding energy transfer was also observed in the O 1s XPS spectrum of FIG. 4H. In the metal catalysts of Manufacturing Examples 9 and 10, a peak was observed at 529.5 eV corresponding to an Ni—O binding energy, but in the metal catalyst of Manufacturing Example 11, a peak occurred in the binding energy of 529.0 eV, and thus, it was confirmed that a heterojunction catalyst of nickel and nickel oxide was formed.

### (Experimental Example 5) Evaluation of Electrochemical NO Oxidation Reaction Performance of Anode

The electrochemical nitric acid oxidation reaction performance of the anodes manufactured by the methods of Manufacturing Examples 9 to 14 was evaluated. The evaluation was performed using a potentiometer (Gamry Instruments Reference 600) in a flow battery equipped with a standard 3-electrode system. The flow battery used an anode as a working electrode, a PT wire as a counter electrode, and Ag/AgCl (in 3M KCl) as a reference electrode. The working electrode and the counter electrode were separated by an anion exchange membrane (Nafion 117) and housed in a separate chamber, and the volume of each chamber was 1 cm³ (1 cm×1 cm×1 cm). An electrolyte was supplied to each chamber while 10 ml of the electrolyte (0.5 M K₂SO₄) was circulated at a flow velocity of 2.0 ml/min using a peristaltic pump.

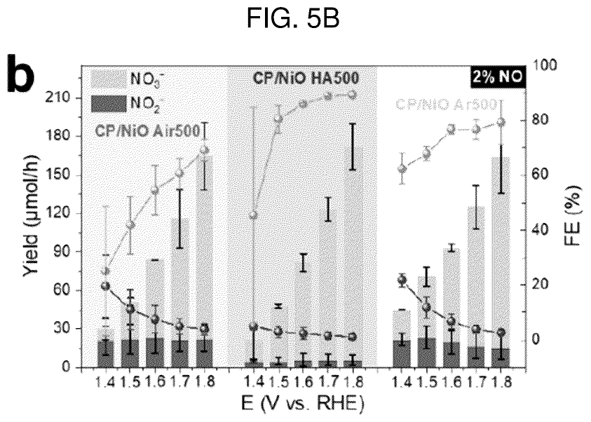

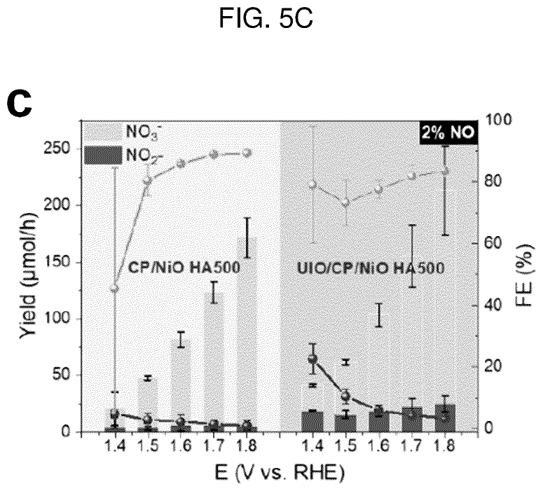

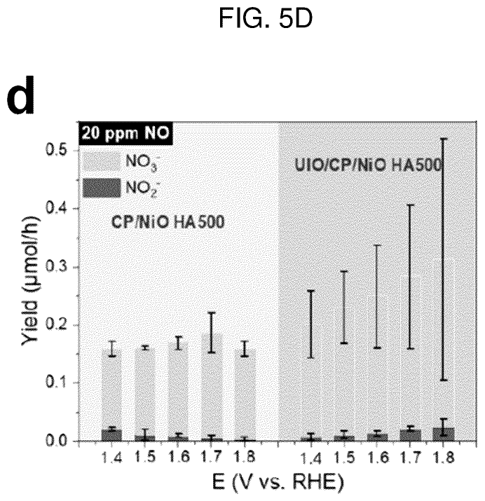

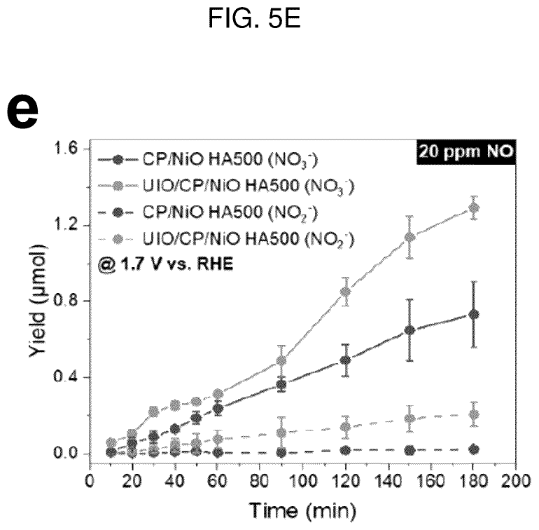

FIG. 5A is a schematic diagram showing a nitrogen oxide adsorption and conversion process of the anode according to an exemplary embodiment, and only the nitrogen oxide in the reactant introduced to the flow battery was selectively captured on MOFs of the anode, and then diffused to the surface of the metal catalyst, thereby performing the electrochemical oxidation reaction. The nitrogen oxide is converted into a nitrate ion by the electrochemical oxidation reaction, and the nitrate ion reacts with an ammonium ion produced in the cathode to produce ammonium nitrate.

FIG. 5B is a graph showing the production rate and the Faradaic efficiency, when a flow battery including the anodes according to Manufacturing Example 12 (CP/NiO Air500), Manufacturing Example 13 (CP/NiO Ar500), and Manufacturing Example 14 (CP/NiO HA500) was operated, using the reactant including 2% NO. As shown in FIG. 5B, since the anode of Manufacturing Examples 12 to 14 had significantly higher yield and Faradaic efficiency of NO₃⁻ than NO₂⁻, it was found that the main product of the electrochemical oxidation reaction of NO was NO₃⁻. Among them, when the anode of Manufacturing Example 14 was used, the NO₃⁻ yield was the highest at 165.6 μmol/h at 1.8 V (vs. RHE), the Faradaic efficiency for NO₃⁻ was also 89.4%, and thus, the electrochemical conversion performance of NO was the best. Therefore, it was found the Ni/NiO heterojunction catalyst may improve the nitrogen oxide conversion performance, lower the selectivity for NO₂⁻, significantly improve the selectivity for NO₃⁻, and thus, is favorable for the manufacture of ammonium nitrate.

FIGS. 5C and 5D are graphs showing the production rate and the Faradaic efficiency by NO concentration according to Manufacturing Example 11 (UIO/CP/NiO HA500) and Manufacturing Example 14 (CP/NiO HA500). Referring to FIGS. 5C showing the production yield and the Faradaic efficiency when a reaction gas including 2% NO was used, the anode of Manufacturing Example 11 had both increased NO₃⁻ yield and NO₂⁻ yield as compared with the anode of Manufacturing Example 14, due to the presence of MOFs having excellent NO adsorption performance. Specifically, since the anode of Manufacturing Example 11 had the NO₃⁻ yield of 187.5 μmol/h and the NO₂⁻ yield of 25.1 μmol/h, the total NO oxidation amount of the NO₂⁻ yield and the NO₃⁻ yield combined was increased by about 24% as compared with Manufacturing Example 14. Besides, the Faradaic efficiency for conversion of NO into NO₃⁻ was maintained at a high value without being lowered, even with the increased No₂⁻ yield.

In addition, referring to FIG. 5D showing the production yield and the Faradaic efficiency when a reaction gas including 20 ppm of NO was used, though the NO content in the reaction gas was significantly decreased, the NO₃⁻ yield of the anode of Manufacturing Example 11 was increased about twice that of the anode of Manufacturing Example 14 at 1.8 V (vs. RHE), and thus, excellent nitrogen oxide conversion performance was shown though the reactant contained low-concentration NO.

FIG. 5E is a graph measuring the NO₂⁻ and NO₃⁻ production yields according to the reaction time of the anodes according to Manufacturing Example 8 (UIO/CP/NiO HA500) and Manufacturing Example 11 (CP/NiO HA500) in 1.7 V (vs RHE). The nitrogen oxide conversion reaction was performed using a reaction gas containing 20 ppm of NO. Though the reaction gas included NO at a low concentration, the NO₂⁻ yield and the NO₃⁻ yield of the anode of Manufacturing Example 11 were consistently higher than those of the anode of Manufacturing Example 14, regardless of the time.

From the results, it was found that though the reaction gas contained the nitrogen oxide at a low concentration, the MOFS of the anode effectively adsorbed the nitrogen oxide in the reactant and diffused to the surface of the metal catalyst. Thus, it was confirmed that the electrochemical conversion reaction efficiency of the nitrogen oxide was effectively improved even with the reaction of the low-concentration nitrogen oxide.

### (Experimental Example 6) Evaluation of Ammonium Nitrate Conversion Performance

The ammonium nitrate conversion performance was evaluated by operating the ammonium nitrate manufacturing apparatuses according to Examples 1 to 3 and Comparative Examples 1 to 3. The evaluation was performed using a potentiometer (Gamry Instruments Reference 600), and the yield of ammonium nitrate (NH₄NO₃) produced when a reaction gas including 20 ppm of NO was used was measured and is shown in FIGS. 6D to 6F. Specifically, FIG. 6D is a graph evaluating the ammonium nitrate conversion performance of the ammonium nitrate manufacturing apparatuses according to Example 1 and Comparative Example 1, FIG. 6E is a graph evaluating that according to Example 2 and Comparative Example 2, and FIG. 6F is a graph evaluating that according to Example 3 and Comparative Example 3.

Referring to FIGS. 6A and 6D, it was confirmed that the ammonium ion manufacturing apparatus formed of a double chamber system in which a section for producing a nitrate ion and a section for producing an ammonium ion are divided, under a 20 ppm of NO gas flow allowed production of ammonium nitrate (NH₄NO₃) by separate production of the nitrate ion (NO₃⁻) and the ammonium ion (NH₄⁺). The ammonium nitrate (NH₄NO₃) production yield of the ammonium nitrate manufacturing apparatus of Example 1 was higher than that of the ammonium nitrate manufacturing apparatus of Comparative Example 1. Since the ammonium nitrate manufacturing apparatus of Comparative Example 1 in which the anode and the cathode did not include MOFs had a significantly low yield for the nitrate ion (NO₃⁻), it was difficult to produce ammonium nitrate.

Referring to FIGS. 6B and 6E, the ammonium nitrate manufacturing apparatus of Example 2 formed of a single chamber which did not include a separator had a higher ammonium nitrate production yield than Comparative Example 2, and an improved ammonium nitrate yield as compared with Example 1. Since the yields of the ammonium ion (NH₄⁺) and the nitrate ion (NO₃⁻) were close to 1:1, it was easy to form ammonium nitrate. It was found that as NO as the reactant and the proton of the electrolyte stably reacted in the anode and the cathode, the electrochemical conversion reaction of NO proceeded actively in each electrode.

Referring to FIG. 6C and 6F, in the ammonium nitrate manufacturing apparatus of Example 3 which was formed of a single chamber, and in which the reactant was not supplied to the anode and the cathode, respectively, then a single gas line in which the reactant passed through the anode and the cathode in series was provided, while the reactant flowed from the cathode to the anode, NO which did not react in the cathode moved to the anode and participated in the reaction. The amount of NO which did not participate in the reaction was minimized to effectively consume NO. In addition, since the ammonium nitrate production yield of the ammonium nitrate conversion apparatus according to Example 3 was about twice as high as that of Comparative Example 3, it was confirmed that the ammonium nitrate conversion efficiency was significantly improved.

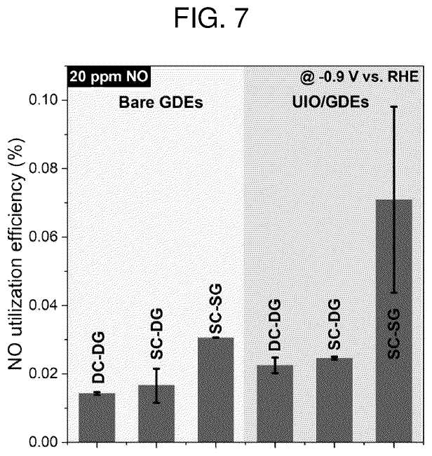

FIG. 7 is a graph measuring the NO utilization efficiency of the manufacturing apparatuses of ammonium nitrate according to Examples 1 to 3 and Comparative Examples 1 to 3. The NO usage efficiency was determined by calculating the ratio of the ammonium nitrate production amount to the amount of NO supplied to the ammonium nitrate manufacturing apparatus. As shown in FIG. 7, the ammonium nitrate manufacturing apparatus of Example 3 which was a single gas flow showed significantly better NO usage efficiency than those of Examples 1 and 2 in which the reactant was supplied to the anode and the cathode, respectively. A larger amount of ammonium nitrate was produced from the same amount of NO by effectively consuming unreacted NO, and since the unreacted NO was not discharged outside the ammonium nitrate manufacturing apparatus, it contributed to improving air pollution.

The ammonium nitrate manufacturing apparatus of the present disclosure and the method for manufacturing ammonium nitrate may produce ammonium nitrate with a high conversion rate from a reactant including a diluted nitrogen oxide. Specifically, the nitrogen oxide in the reactant may be selectively adsorbed, and then rapidly diffused to the surface of a metal catalyst to improve nitrogen oxide conversion efficiency.

In addition, an amount of the nitrogen oxide which does not participate in the reaction may be minimized to provide a high ammonium nitrate yield using a small amount of nitrogen oxide.

Furthermore, nitrogen oxides which cause air pollution may be converted into high value-added ammonium nitrate by an economical, energy-efficient, and simple process.

Hereinabove, although the present invention has been described by specific matters, limited exemplary embodiments, and drawings, they have been provided only for assisting the entire understanding of the present invention, and the present invention is not limited to the exemplary embodiments, and various modifications and changes may be made by those skilled in the art to which the present invention pertains from the description.

Therefore, the spirit of the present invention should not be limited to the above-described exemplary embodiments, and the following claims as well as all modifications equal or equivalent to the claims are intended to fall within the scope and spirit of the invention.

What is claimed is:

1. An ammonium nitrate manufacturing apparatus for manufacturing ammonium nitrate from a diluted nitrogen oxide, the apparatus comprising:
a cathode;
an anode which is arranged to be opposite to and spaced apart from the cathode; and
an electrolyte placed between the anode and cathode,
wherein the cathode and the anode are independently of each other gas diffusion electrodes including: a porous substrate; metal organic frameworks (MOFs) dispersed in the porous substrate; and a metal catalyst placed on one surface of the porous substrate.

2. The ammonium nitrate manufacturing apparatus of claim 1, wherein the cathode and the anode include different types of metal catalysts.

3. The ammonium nitrate manufacturing apparatus of claim 1, wherein the cathode contains copper as the metal catalyst.

4. The ammonium nitrate manufacturing apparatus of claim 1, wherein the anode contains nickel (Ni), nickel oxide (NiO), or a combination thereof as the metal catalyst.

5. The ammonium nitrate manufacturing apparatus of claim 1, wherein the metal organic frameworks (MOFs) are dispersed inside pores and on a surface of pores of the porous substrate.

6. The ammonium nitrate manufacturing apparatus of claim 1, wherein the metal organic frameworks (MOFs) include coordinatively unsaturated metal sites (CUMSs).

7. The ammonium nitrate manufacturing apparatus of claim 1, wherein the porous substrate includes a porous carbon body.

8. The ammonium nitrate manufacturing apparatus of claim 1, further comprising: a first fluid housing part placed on one surface of the cathode; and a second fluid housing part placed on one surface of the anode.

9. The ammonium nitrate manufacturing apparatus of claim 8,
wherein the first fluid housing part includes a first fluid inlet and a first fluid outlet, and
the second fluid housing part includes a second fluid inlet and a second fluid outlet.

10. The ammonium nitrate manufacturing apparatus of claim 9, further comprising: a flow path which connects the first fluid outlet and the second fluid inlet.

11. The ammonium nitrate manufacturing apparatus of claim 1, wherein the electrolyte is housed in an electrolyte housing part placed between the anode and the cathode and is in contact with at least a part of the anode and the cathode.

12. The ammonium nitrate manufacturing apparatus of claim 11, wherein the electrolyte housing includes an electrolyte inlet and an electrolyte outlet on one side.

13. The ammonium nitrate manufacturing apparatus of claim 1, wherein the ammonium nitrate manufacturing apparatus is a flow battery for converting nitrogen oxides.

14. The ammonium nitrate manufacturing apparatus of claim 1, wherein the anode, the cathode, and the electrolyte are housed in a single chamber.

15. A method for manufacturing ammonium nitrate, the method comprising:
(S10) supplying a reactant containing a nitrogen oxide to a cathode and an anode of the ammonium nitrate manufacturing apparatus to produce an ammonium ion in the cathode and produce a nitrate ion in the anode; and
(S20) reacting the nitrate ion and the ammonium ion to manufacture ammonium nitrate,
wherein the ammonium nitrate manufacturing apparatus is an apparatus for manufacturing ammonium nitrate from a diluted nitrogen oxide, and includes:
a cathode;
an anode which is arranged to be opposite to and spaced apart from the cathode; and
an electrolyte placed between the anode and cathode,
wherein the cathode and the anode are independently of each other gas diffusion electrodes including: a porous substrate; metal organic frameworks (MOFs) dispersed in the porous substrate; and a metal catalyst placed on one surface of the porous substrate.

16. The method for manufacturing ammonium nitrate of claim 15, wherein (S20) is performed in the electrolyte of the ammonium nitrate manufacturing apparatus.

17. The method for manufacturing ammonium nitrate of claim 15, wherein (S10) is supplying the reactant to each of the cathode and the anode.

18. The method for manufacturing ammonium nitrate of claim 15, wherein (S10) includes:
(S11) supplying a reactant containing a nitrogen oxide to the cathode to produce an ammonium ion; and
(S12) supplying a reactant containing an unreacted nitrogen oxide discharged from the cathode to the anode to produce a nitrate ion.

19. The method for manufacturing ammonium nitrate of claim 15, wherein a content of the nitrogen oxide in the reactant is 50 ppm or less.
